(19) United States
(12) Patent Application Publication
(10) Pub. No.: US 2006/0068962 A1
(43) Pub. Date: Mar. 30, 2006

(54) Control units

(76) Inventor: Reginald Charles Allsopp, Stockport (GB)

Correspondence Address: Haugen Law Firm PLLP, 1130 TCF Tower, 121 South Eighth Street, Minneapolis, MN, 55402, US

(21) Appl. No.: 11/232,829

(22) Filed: Sep. 22, 2005

(30) Foreign Application Priority Data
Sep. 27, 2004 (GB) 0421385.6

(51) Int. Cl. F16H 9/26

(52) U.S. Cl. 475/182

(57) ABSTRACT

A control unit for use in a window blind head rail assembly including a system of transfer gears coupled to a driving member, the transfer gear system comprising a rotatable inner ring gear; one or more intermediate gears having fixed positions relative to the sprocket support and being rotatable about their own axes; a rotatable outer ring gear connected to a driven member; wherein rotation of the inner ring gear causes rotation of the one or more intermediate gears about their own axes, which causes rotation of the outer ring gear. The driving member has a driving pulley so that force applied to the driving member will cause rotation of the driving pulley and then the gears. A sprocket support and braking means to prevent the control unit from rotating other than in response to force applied via the driving member are also essential as is a splined bush.

### CROSS-REFERENCE TO RELATED APPLICATIONS

This application claims priority to Great Britain patent application serial no. 0421385.6, filed on Sep. 27, 2004, and entitled “CONTROL UNITS”, the contents of which are herein incorporated in their entirety.

### FIELD OF THE INVENTION

The present invention relates to improvements in control units, specifically to control units for window blind systems.

### BACKGROUND OF THE INVENTION

Due to the general inaccessibility of window blind head rails, and the complexity of modern blinds, it is necessary for window blinds to comprise a control unit, and many types are known in the art. The nature of the control unit will vary according to the type of blind with which it is being used, and the present invention relates in particular to manually operated control units beneficially for use with large and/or heavy blinds.

Control units of this type may be used to hang any suitable blind where a control unit as described can be applied, but most commonly roller blinds.

A control unit for use with a roller blind type head rail will typically include a driving pulley in connection with driving means such as a chain, and a sprocket wheel which transmits rotational motion from the driving member, and which in turn causes a splined bush to rotate. Braking means such as a wrap spring will also typically be present to provide a controlled and limited resistance to rotation.

The control unit may engage a roller blind tube, via the splined bush causing an attached blind to raise or lower as a result of the operation of the driving means. In this way, movement of the blind from an open to a closed position is achieved without excessive stretching or discomfort to the individual.

A control unit which exemplifies this mechanism is disclosed in British patent No. 2392703 in the name of Louver-Lite Limited. This unit comprises a sprocket wheel and housing, in which the sprocket wheel interacts with a wrap spring of substantially circular cross-section having flattened juts. The wrap spring is in turn connected to a sprocket support by a sprocket support spring friction surface. The sprocket support includes engaging pins which are designed to interact with a wall or ceiling mounted bracket, thereby providing means for hanging the blind in front of a window or other aperture. In addition, the sprocket support includes recesses designed to interact with fins integral to a centre-pin which extends substantially through the centre of the assembled control unit and includes two locking lugs at the tip of the pin which snap-fit over a splined bush and retain the unit in an assembled conformation. The chain guard housing described in GB-A-2392703 may rotate relative to the sprocket support and includes a positioning lug extending perpendicularly from the face of the control unit which incorporates the sprocket support.

As the size and weight of a window blind is increased, the size of control units of the type described in GB-A-2392703 must also be increased. This allows the control unit to possess the strength to raise and lower the blind, in addition to providing sufficient braking to prevent the blind unrolling under gravity.

The increase in size of the control unit is sometimes regarded as lacking in aesthetic appeal, and as a result it is desirable to produce a control unit which can be used with large, heavy blinds but which does not require a consequent increase in the volume of the control unit. In addition, as a window blind increases in size, the effort required by the user to change the position of the blind becomes greater. In particularly large or heavy blinds this could necessitate the use of motor driven blind mechanisms.

Many motor driven control units are known in the art. Typically, motor driven control units are more complicated to manufacture and install than simple manually operated systems. Accordingly, motor driven control units are usually also more expensive than manually operated systems.

WO 03/080981 in the name of Rollease, Inc. describes a roller shade clutch with internal planetary gearing. The clutch unit of WO 03/080981 comprises a protective guard including a stationary sun gear and a support for a two wrap-spring brakes. The sun gear is connected to the outer gear via planet gears which may rotate both upon their own axes, and around the rotational axis of the sun gear. The outer gear is integral with the driving pulley of the clutch unit and the rotational output is via a spring drive connected to the planet gears.

DE 200 22 527 U1 in the name of MHZ Hachtel GmBH also describes a clutch unit with internal planetary gears. The gear mechanism of DE 200 22 527 works in a similar manner to the gear mechanism of WO 03/080981.

In the systems of WO 03/080981 and DE 200 22 527 rotational output is via the rotation of the planetary gears around the sun gear. The planetary gears are mounted on a plate, which plate is caused, upon rotation of the planetary gears to transmit this rotational motion to an output member.

Wear and tear on the planetary gears and planetary gear mounting plate may be a problem, due to the complex nature of this component and the relatively fragile pins connecting the planet gears to the mounting plate. In both WO 03/080981 and DE 200 22 527, this problem may be exacerbated by the necessity that these components transmit the rotational motion generated by actuation of the control unit to the blind itself.

There is therefore a need for a simple, manually operated control unit which has a compact structure and requires a reduced force to operate. There is also a need for a control unit in which the wear and tear of the fragile and complex planetary gear system is reduced.

### SUMMARY OF THE INVENTION

The applicants have found that the introduction of a system of transfer gears into a control unit can provide a control unit which is both compact and easy to operate. The transfer gears provide a mechanical advantage, facilitating easy operation of the blind by the user. The use of a gear reduction by transfer system comprising a inner ring gear, an outer ring gear and one or more intermediate gears wherein the intermediate gears may rotate upon their own axes but not around the rotational axis of the inner ring gear, and wherein each intermediate gear is meshed with both the inner and outer ring gears, offers substantial gear reduction ratios in a compact unit. Further, the transmission of rotational motion in the invention is via the outer ring gear, which in turn is part of the driven member. This component may be more robust than the planetary gear mounting plates of the prior art, thereby prolonging the life of the control unit.

According to the invention there is provided a control unit for use in a window blind head rail assembly as defined in claim 1. A suitable control unit includes; a driving member with a driving pulley so that force applied to the driving member will cause rotation of the driving pulley; a system of transfer gears coupled to the driving member, the transfer gear system comprising a rotatable inner ring gear conveniently located on the driving member with teeth projecting outwards from the rotational axis of the inner ring gear; one or more intermediate gears having fixed positions relative to a sprocket support and being rotatable about their own axes; and a rotatable outer ring gear conveniently with teeth projecting towards the rotational axis of the outer ring gear and which is connected to a driven member; wherein rotation of the inner ring gear causes rotation of the one or more intermediate gears about their own axes, which causes rotation of the outer ring gear; a sprocket support and braking means to prevent the control unit from rotating other than in response to force applied via the driving member; and a splined bush.

The driving member of the invention is preferably annular, and comprises an outer and inner face. The outer face of the driving member is the face adjacent to the sprocket support when the control unit is assembled for use.

The inner face of the driving member preferably comprises a driving pulley and a inner ring gear. The driving pulley forms a ring around the outer edge of the inner face of the driving member and conveniently is adapted to engage a chain in use. The application of force to the chain causes the driving pulley to rotate, in turn causing the inner ring gear to rotate transmitting rotational motion through the gear system to the driven member.

It will be understood that the term chain also encompasses cords, ribbons and the like which are known in the art. Integral to the chain is a series of regularly spaced balls which when fed through the control unit interact with the driving pulley causing it to rotate. These may be of either metal or plastic construction.

The inner ring gear is preferably positioned at the inner edge of the inner face of the annular driving member conveniently adjacent to a central mounting orifice on the annular driving member, and may comprise a circular outwardly pointing teeth arrangement. Preferably, either the driving pulley or the inner ring gear are molded integrally with the driving member. More preferably, both the driving pulley and the inner ring gear are molded integrally with the driving member so that this component is of one-piece construction.

The inner ring gear is meshed with one or more intermediate gears so that rotation of the inner ring gear is transmitted to the intermediate gear or gears when the driving member rotates.

The intermediate gear or gears are preferably mounted on a non-rotatable plate. The plate may comprise a substantially planar annular disc mounted on an axially central substantially cylindrical portion. The face of the non-rotatable plate on which the intermediate gears are not mounted may comprise a cylindrical portion extending outward from the inner edge of the annular plate. In one embodiment the cylindrical portion provides a friction surface for interaction with the braking means. This interaction controls the speed of rotation of the elements of the control unit providing a braking effect in the absence of rotation. Where the cylindrical portion of the non-rotatable plate functions as a friction surface, the cylindrical portion of the sprocket support is preferably absent.

The intermediate gear or gears may be mounted in any position around the annular disc, preferably however they will be equidistantly spaced both from the other intermediate gears present and between the inner and outer edge of the disc. The intermediate gear or gears are preferably mounted on one or more pins extending perpendicularly from the face of the mounting plate. However, it will be understood that other methods of mounting the intermediate gears may be used as appropriate.

It is to be appreciated that other numbers of intermediate gears may be used, such as from one to six intermediate gears. In preferred embodiments between three and five intermediate gears are used. If the intermediate gears are to be equidistantly spaced around the inner ring gear, it is preferable that an odd number of gears are used. This limits movement of the inner ring gear within the transfer system to one direction relative to the outer ring gear at any time. This prevents unequal wear and eccentric movement of the inner ring gear. Eccentric movement of the inner ring gear is undesirable as this may make the system more difficult to operate. It is therefore preferable that there are three or five intermediate gears, most preferably three.

The non-rotatable plate is preferably designed to engage with the sprocket support so that rotation of the non-rotatable plate around the sprocket support is prevented. This may typically be achieved by engagement of a non-cylindrical portion of the non-rotatable plate with a co-operating portion of the sprocket support.

The intermediate gear or gears also mesh with the outer ring gear. Rotation of the intermediate gears causes the outer ring gear to rotate transmitting rotational motion to the driven member.

The mechanical advantage of the transfer gear system is typically in the range 10:1 to 1:1, preferably in the range 5:1 to 1:1, more preferably in the range 3.5:1 to 1:1 or 2:1 to 1:1.

In use, the intermediate gears may rotate around their own axes, but not around the rotational axis of the inner ring gear. Accordingly, the gear system of the invention is not a planetary gear system, as no orbit of the intermediate gears around the inner ring gear occurs. As a result, the rotational motion of the gear system is not transmitted through rotation of the mounting plate of the intermediate gears, as is observed in planetary gear systems, but through the transmission of the rotational motion from the inner ring gear, through the rotating but otherwise stationary intermediate gears, to the outer ring gear which itself rotates. In planetary gear systems it is the sun gear or the annular gear which is static. In the gear system of the invention, the “static” component of the gear system is the intermediate gear or gears, although the intermediate gear or gears do in use rotate.

The driven member may include the outer ring gear. The outer ring gear has inwardly pointing teeth and is present on one face of the driven member. Preferably, the outer ring gear is integrally molded with the driven member.

The driven member may have a tubular portion in which is located a cutaway portion. When the control unit is assembled, the tubular portion preferably extends away from the face of the driven member not incorporating the outer ring gear. When the control unit is assembled the tubular portion of the driven member may be telescopically positioned over the sprocket support and braking means positioned between a cylindrical friction surface of either the sprocket support or the non-rotatable plate and tubular portion of the driven member. Rotation of the driven member is thus restricted when the control unit is in use.

The braking means in the control unit may be any braking mechanism known in the art. Preferably, the braking means will be one or more wrap springs; conveniently, the braking means will be one wrap spring only. However in some embodiments two or more wrap springs may be present.

Where more than one wrap spring is used, the internal volume of the control unit may be increased. One aim of the invention is to produce a compact control unit; as a result, the addition of further wrap springs is undesirable. Where wrap springs are used in the invention, they may be of circular or rectangular cross-section. Preferably, they will be of generally circular cross-section, with modified wrap spring juts. Where the juts have been modified, the modification will be such that each jut has one or more flattened surfaces, and if only one surface has been flattened that this is on the face of the jut which contacts the edges of the cutaway portion of the driven member. If the cross-sectional shape of the juts is modified in this way, the contact area of the spring with the driven member contact surface is increased, improving purchase and decreasing wear of the driven member in use.

If a wrap-spring is used, this is preferably formed from metal, or a plastics material, preferably from metal and more preferably from steel.

The control unit also includes a sprocket support. In one embodiment, the sprocket support comprises a roughly cylindrical portion and connected to one end, a collar which forms the external face of the sprocket support, and which is substantially annular. The cylindrical portion of this component extends directly from the inner edge of the sprocket support face engaging the driven member and provides a friction surface for interaction with the braking means. Where the friction surface forms part of the sprocket support, the interaction of the friction surface with the braking means controls the speed of rotation of the elements of the control unit in use, and also provides a braking effect in the absence of rotation. In an alternative embodiment, the friction surface is the cylindrical portion of the non-rotatable plate. In this embodiment the cylindrical portion of the sprocket support is preferably substantially absent.

The sprocket support also includes a portion which engages the non-rotatable plate to prevent rotation of the non-rotatable plate around the rotational axis of the inner ring gear.

Preferably, the external face of the sprocket support collar comprises one or more engaging pins for engagement with a window blind mounting bracket. Typically, there will be two engaging pins. The external face of the sprocket support collar is the face adjacent to the bracket when the control unit is mounted for use.

It is preferred that the external face of the sprocket support collar may include one or more recesses around the inner edge of the annular collar which forms this face of the sprocket support. These are adapted to engage with one or more fins which may optionally be present, where a centre-pin is present, on a locking-lug of the centre-pin stop element.

The units may be held together by a centre-pin. Where present, the centre-pin extends substantially through the centre of the control unit. The head of the pin may comprise a locking-lug of a centre-pin stop element typically in the form of co-operating flattened surfaces in what is otherwise a tubular interface between the centre-pin and the sprocket support. In addition, there may be a hooked tip extending from the centre-pin stop element to engage a bracket when the blind is mounted. The end of the centre-pin distal to the centre-pin head typically comprises two tips. The splined bush snap fits over the centre-pin tips whereby two locking lugs at the tip of the centre-pin engage a centre-pin engagement surface of the splined bush. Alternative ways, such as using star washers, etc exist for anchoring the centre-pin and the splined bush in the control unit, but the use of integral locking lugs provides a cheap and reliable means of securing the centre-pin.

There are one or more molded indents on the internal surface of the splined bush, one or more of which, in the assembled unit, sits within the cutaway portion of the driven member. In use, upon relative rotation the molded indent contacts the cutaway portion of the driven member component. As the driven member rotates, an edge of the cutaway portion rotates to contact an edge of the molded indent or indents on the splined bush, and the splined bush is caused to rotate. It is the rotation of splined bush caused by rotation of the driven member which causes the roller blind tube to rotate, in turn causing the blind to be raised or lowered as required.

Optionally, the control unit may also include a chain guard housing. Where present, the chain guard housing of the invention covers the driving pulley and is preferably substantially flush with the external face of the sprocket support collar when the unit is assembled, however this is not essential. Covering the driving pulley in this way prevents the chain from becoming dislodged during use, and provides a more aesthetically pleasing unit to the user.

With the exception of the wrap spring, the components of the control unit will typically be made from polymer plastics materials. The different components may be made from any thermoplastics materials, such as e.g. nylon, which are compatible with modern injection molding techniques and known to those skilled in the art. Alternatively, where appropriate components may be made out of metals.

Preferably, each individual component of the invention is formed separately from the other components, and when made from plastics from one piece of molded plastics material.

### BRIEF DESCRIPTION OF THE DRAWINGS

FIGS. 1a and 1b are perspective front and rear views of a control unit according to the invention;

FIGS. 2a and 2b are perspective exploded front and rear views of the control unit of FIGS. 1a and 1b;

FIG. 3a is a perspective view of a plastic bracket adapted to receive the control unit of FIGS. 1a and 1b;

FIG. 3b is a perspective view of metal bracket adapted to receive the control unit of figures la and lb.

### DETAILED DESCRIPTION OF THE PREFERRED EMBODIMENTS

For the avoidance of doubt it should be noted that in this specification reference to ‘up’, ‘down’, ‘upper’, ‘lower’, ‘vertical’, ‘horizontal’, ‘front’, ‘back’, ‘bottom’, ‘top’ and related terms refers to the orientation that the components of the blind adopt when installed for normal use, as they are shown in the figures.

Unless otherwise stated all sizes described herein are to be taken as modified by the word ‘about’.

The objects and advantages enumerated above together with other objects, features, and advances represented by the present invention will now be presented in terms of detailed embodiments described with reference to the attached drawing figures which are intended to be representative of various possible configurations of the invention. Other embodiments and aspects of the invention are recognized as being within the grasp of those having ordinary skill in the art.

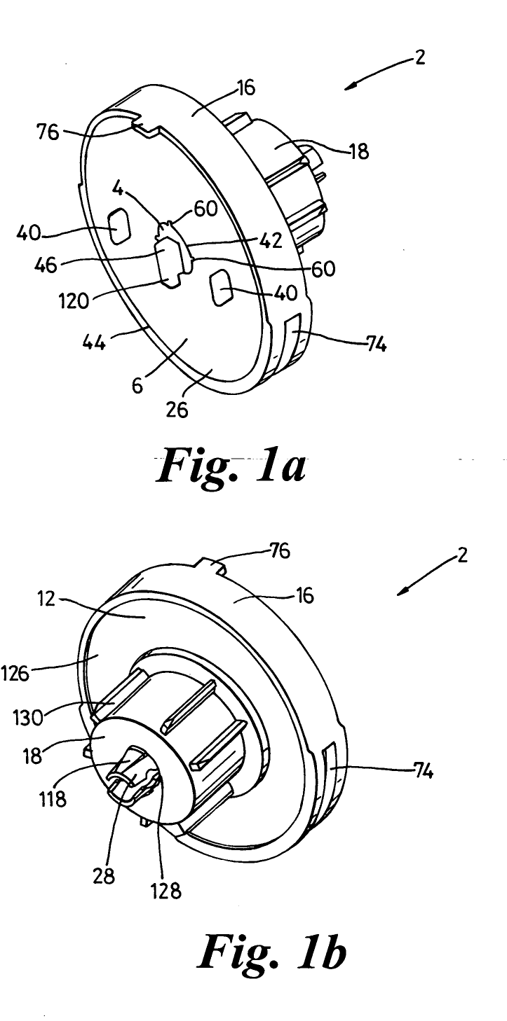

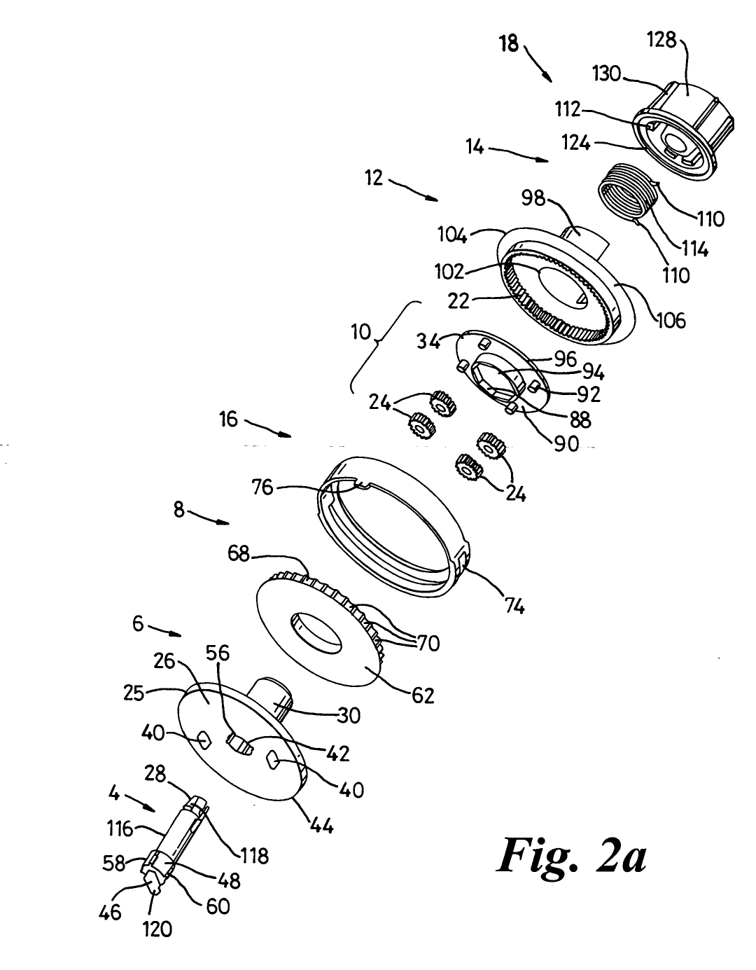

FIGS. 1a, 1b, 2a and 2b show a control unit 2 falling within the scope of the invention. In the embodiment described below the unit is assembled by aligning the elements of unit 2 as shown in FIGS. 2a or 2b, inserting the centre-pin 4 through all elements and allowing it to lock. The control unit 2 generally comprises a sprocket support 6, a driving member 8, a system of transfer gears 10, a driven member 12, a wrap spring 14, a chain guard housing 16 and a splined bush 18. When assembled, pulling on a chain (not shown) causes rotation of an inner ring gear 20, which in turn causes rotation of an outer ring gear 22 via a system of intermediate gears 24, which rotate on their own axes but which otherwise remain stationary. This causes rotation of the driven member 12 and the splined bush 18.

The control unit of this embodiment has components sized such that the splined bush 18 will engage a 40 mm diameter roller blind tube.

In this embodiment, sprocket support 6 comprises a substantially annular collar 25 and has extending towards the rear of control unit 2 (i.e. the end of control unit 2 at which the tips 28 of the centre-pin 4 may be found when control unit 2 is assembled) from the inner edge of the annulus, a roughly cylindrical portion 30. Typically, sprocket support 6 is an injection molded plastics material. The cylindrical portion 30 of this component is of two diameters, the larger diameter portion 32 of the cylindrical portion 30 extending directly from sprocket support collar 25 and of a size to engage a non-rotatable plate 34.

The larger diameter portion 32 of the cylindrical portion 30 includes a region of non-circular, preferably polygonal, cross-section. In this embodiment, the cross-section of larger diameter portion 32 is octagonal. This larger diameter portion 32 of cylindrical portion 30 engages a corresponding portion in the non-rotatable plate 34 preventing rotation of the intermediate gears 24 around the rotational axis of inner ring gear 20 in use. The smaller diameter portion 38 of the cylindrical portion 30 provides a spring friction surface (also denoted by reference numeral 38) and extends beyond the larger diameter portion 32 towards the rear of control unit 2.

Sprocket support 6 includes two engaging pins 40 which are rectangular with rounded corners and which project from the external face 26 of sprocket support collar 25. The engaging pins 40 are aligned equidistantly between the inner and outer edges 42,44 of external face 26 of sprocket support collar 25 with long axes parallel to one another and parallel to a locking-lug 46 of the centre-pin stop element 48. Engaging pins 40 and centre-pin stop element 48 are received by cooperating recesses 50 in a mounting bracket 52, 54 when the blind is installed.

Sprocket support 6 of the present embodiment additionally comprises three recesses 56 positioned around, and extending radially from, the inner surface of the ring of the external face 26 of the sprocket support collar 25 which receives centre-pin head 58. Recesses 56 are spaced 900 apart on the left, right and at the top of the inner edge when the control unit is in use. Recesses 56 are adapted to receive three fins 60 which extend from the centre-pin head 58.

The driving member 8 of the embodiment described engages a chain. Upon movement of the chain driving member 8 rotates. This rotation causes the inner ring gear 20 to rotate. The driving member 8 is nylon and of one-piece molded construction. The shape of the driving member 8 is substantially annular and has two faces 62, 64. Outer face 62 is substantially smooth, inner face 64 incorporates both a driving pulley 68 and inner ring gear 20. Driving pulley 68 comprises a ring of regularly spaced recesses 70 designed to accommodate the balls of a chain during use.

The chain for use with this control unit will typically comprise a cord of metal or plastic links with a series of balls spaced e.g. 7 mm or so, which may engage recesses 70 (but not necessarily each recess 70; the chain may for example engage every other recess 70). The chain may be held in place by the inner annular surfaces of chain guard housing 16. It is this interaction between the chain and driving pulley 68 which when the chain is pulled causes rotation within the unit.

The inner ring gear 20 forms the inner edge of the annulus. The teeth 72 of the inner ring gear 20 extend outwards from the rotational axis of the driving member 8 so that they may mesh with the intermediate gears 24.

In this embodiment, driving pulley 68 is covered by chain guard housing 16 positioned substantially flush with external face 26 of sprocket support collar 25 and sized to surround and loosely engage external face 26 of sprocket support collar 25. Chain guard housing 16 also comprises an aperture 74 through which the chain hangs. The chain guard housing 16 is constructed from an injection molded plastics material.

The chain guard housing 16 or the sprocket support 6 may include one or more positioning lugs 76, which extend perpendicular to the face of the control unit 2 which incorporates the sprocket support 6. The one or more positioning lugs 76 may be positioned at any point around this face 26 of the control unit 2, and may be connected to either the chain guard housing 16 or to the sprocket support 6. Preferably, there will be between one and three lugs 76. In this embodiment there is one lug 76 which is integrally molded with the chain guard housing 16. Typically, although not exclusively, lug 76 is positioned to extend perpendicular to the face of control unit 2 which incorporates the sprocket support 26 and from the top centre of this face 26 when control unit 2 is in use (i.e. from the edge opposite to the chain guard housing aperture 74). Preferably, the mounting bracket 52, 54 has a recess 78 which cooperates with lug 76 during assembly, and ensures that the chain guard housing 16 (which is otherwise capable of rotating about the driving member 8) is correctly orientated when assembled. Preferably, the correct orientation provides for the aperture 74 to be situated pointing symmetrically vertically downwards, which in turn facilitates the chain to hang vertically downwards.

Preferably, the chain guard housing 16 may move relative to the sprocket support 6 such that the chain guard housing 16 may rotate through 360 degrees relative to the external face 25 of the sprocket support collar 25.

The inner ring gear 20 forms part of the driving member 8 and is arranged so that it may mesh with each of four intermediate gears 24 so that rotation of the inner ring gear 20 in response to movement of the driving pulley 68 is transmitted to the intermediate gears 24.

The intermediate gears 24 are mounted on non-rotatable plate 34. The plate 34 comprises an annular disk 80 and extending from the inner edge of the annulus 80 a short cylindrical portion 82 which engages the sprocket support 6. The cylindrical portion 82 preferably has walls of two different thicknesses. The portion of the cylinder 84 proximal to the disk 80 typically but not exclusively has a wall which is thicker than the wall of the portion distal 86 to the disk 80. This allows the inner surface 88 of the portion 84 of the cylinder closest to the disk 80 to comprise an non-circular cross-section. This portion 84 of the cylinder 82 engages with the co-operating portion 32 of the sprocket support 6 to prevent rotation of the non-rotating plate 34 within the control unit 2. The distal portion of the cylinder 86 is sized to fit within the tubular portion 98 of driven member 12.

The cross-section of inner surface 88 may be elliptical, or irregular shape or polygonal. Where the cross-section is polygonal the number of sides of the cross-section may be in the range four to 10, preferably, in the range six to eight. In this particular embodiment, the cross-section is substantially octagonal.

The intermediate gears 24 are mounted on the annular disk 80 of the non-rotatable plate 34 on the face of the disk 90 away from the cylindrical portion 82. Each of the intermediate gears 24 are mounted on pins 92 which extend perpendicular to the plane of the disk 90. The pins 92 are positioned equidistant from the other pins 92 and equidistant between the inner and outer edges 94, 96 of the annular disk 90.

When the driving pulley 68 is rotated, the inner ring gear 20 rotates, this in turn causes the intermediate gears 24 to rotate around their own axis whilst remaining stationary in relation to the inner ring gear 20. In this embodiment there are four intermediate gears 24. The intermediate gears 24 also mesh with outer ring gear 22 so that rotation of the intermediate gears 24 causes the outer ring gear 22 to rotate in turn. This rotation of the outer ring gear 22 transmits rotational motion through the driven member 12 and to the splined bush 18.

The components of the transfer gear system 10 are preferably formed from Nylon.

The intermediate gears 24 are sized so that they mesh with both the inner and outer ring gears 20, 22. The mechanical advantage obtained by the system of transfer gears described in this embodiment of the invention is 1.8:1.

Driven member 12 is of plastics construction and has a tubular portion 98, in which is located a cutaway portion 100. This tubular portion 98 is connected to the inner edge 102 of a further annular collar 104. The outer ring gear 22 is integral to the face 106 of the annular collar 104 of the driven member 12 which does not incorporate the tubular portion 98.

The tubular portion 98 is telescopically positioned over spring friction surface 38 of sprocket support 6 and a wrap spring 14 positioned in a friction-fit over the spring friction surface 38. The edges of the cut-away portion 108 of the driven member 12 engage the wrap spring juts 110 and the molded indent or indents 112 of splined bush 18 in use, forcing these components to rotate.

A steel wrap spring 14 rests on and engages sprocket spring friction surface 38 which interacts with, and provides a friction-fitting surface for the spring. The friction generated between these two components prevents rotation of the blind until a certain minimum rotation force is applied to the control unit 2, by pulling the chain. When the driving member 8 is static, the wrap spring 14 tightly grips the spring friction surface 38. Once the minimum force has been exceeded, the wrap spring 14 temporarily releases itself from sprocket spring friction surface 38, and permits rotation. In addition, it is the friction caused by the movement of these two components relative to one another, which controls the speed of rotation of the elements of control unit 2.

Wrap spring 14 terminates in juts 110, which project radially outwards. In the assembled unit, juts 110 are located in the axial gap between the spring friction surface 38 of the sprocket support 6 and the inner surface of tubular portion 98 of driven member 12. More specifically, they sit in the gaps between edges of cutaway portion 108 of the driven member 12, and the one or more molded indents 112 of splined bush 18. Preferably there will be one indent 112 only positioned between the wrap spring juts 110.

Rotation of the driven member 12 causes edges 108 of cutaway portion 100 to abut against internal sides of molded indent 112, and hence rotate splined bush 18. However, rotation of driven member 12 does not instantaneously cause rotation of splined bush 18, since cutaway portion 100 always represents a greater portion of arc in size than does molded indent 112, so there is always some play between them until rotation of the driven member 12 eventually causes rotation of splined bush 18. Which edge of cutaway portion 108 abuts against which side of molded indent 112 is determined by the direction of rotation of driven member 12, which in turn is determined by which direction around the driving member 18 the chain is pulled. Accordingly, in a full assembly, the blind is raised or lowered.

Wrap spring 14 of this embodiment, comprises seven full coils of steel (wound to the left) plus an additional part coil corresponding to an additional 155°. Two juts 110 extend outwards from the coil 114. The coil 114 has a circular cross-section. However, the juts 110 have been flattened to form a non-circular cross-section in which two opposite faces of the jut 110 have been flattened. This increases the contact area with the edge 108 of the cutaway portion 100 of driven member 12.

In this embodiment a centre-pin 4 is present to retain the components of the control unit 2 in an assembled configuration. Centre-pin 4 is of plastics construction and has a head 58, a body 116 which extends substantially through the centre of control unit 2 and two tips 28. The two centre-pin tips 28 are shaped to include two locking lugs 118 over which splined bush 18 snaps into position. Thereby securing the components of the control unit 2 in an assembled configuration. There is a central bore through each component of the control unit 2. This bore is designed to receive centre-pin 2.

Centre-pin head 58 comprises a locking-lug 46 of the centre-pin stop element 48. This feature engages the sprocket support collar 25 and typically has a flattened surface which cooperates with a corresponding flattened surface on sprocket support 6 to prevent rotation between them. It will be appreciated, however, that rotation of the centre-pin 4 relative to the sprocket support 6 could be prevented in other ways. The locking-lug 46 of centre-pin stop element 48 additionally comprises a hooked tip 120 which engages with a bracket 52, 54.

Optionally, the centre-pin 4 may include one or more fins 60 extending radially from the centre-pin stop element 48 and engaging with cooperating recesses 56 in the external face 26 of the sprocket support collar 25. When present, there will typically be between at least one and seven fins 60, which preferably will be equally spaced around the circular portion of the peripheral surface of centre-pin 4. In this embodiment of the invention the centre-pin 4 includes three fins 60. The fins 60 are spaced 90° apart on the left, right and top of the centre-pin stop element 48 when the control unit 2 is assembled and in use.

Conveniently the fins 60 may run the whole length of the centre-pin 4; alternatively they may be tapered along the length of the pin 4, having a maximum annular length nearest the head 58 of the centre-pin 4, and tapering to nothing at a point along the centre-pin 4 remote from the head 58 of the centre-pin 4. In certain embodiments the fins 60 may extend outwards from the centre-pin 4 a distance of up to about 4 mm; conveniently the fins 60 will extend a distance of between 1 mm and 3 mm outwards from the centre-pin 4 adjacent to the centre-pin head 58. In this embodiment the fins 60 have a maximum annular length at the head 58 of the centre-pin 4 and taper along the length of the pin 4 for 3 mm.

If fins 60 are utilized on the centre-pin 4, in all instances the recesses 56 on the external face of the sprocket support collar 26 are dimensioned and positioned so as to co-operate with the fins 60.

On assembly the splined bush 18 snap fits over centre-pin tips 28, whereby the two centre-pin locking lugs 118 engage a centre-pin engagement surface 122 of the splined bush 18. As with centre-pin 4, splined bush 18 is of one-piece plastics construction. Splined bush 18 comprises a cap front 124 which lies adjacent to the rear face 126 of driven member 12 in use (i.e. the face of the driven member 12 which incorporates tubular portion 98). Extending through the control unit 2, away from driven member 12, the cap front 124 is connected to a roughly cylindrical portion 128 the external surface of which incorporates a series of splines 130. It is this surface which provides purchase on, and causes rotation of, the roller blind tubing (not shown). The internal surface of the cylindrical portion 128 of the splined bush 18 also comprises a molded indent 112. As previously described, in use rotation of the driven member 12 causes the indent 112 to be engaged by the edges 108 of cut-away portion 100 of the tubular portion 98 of the driven member 12, which causes rotation of splined bush 18. The most rearward portion of splined bush is the centre-pin engagement surface 122 and it is the interaction of the centre-pin engagement surface 122 with centre-pin locking lugs 118 that holds the control unit 2 together during operation.

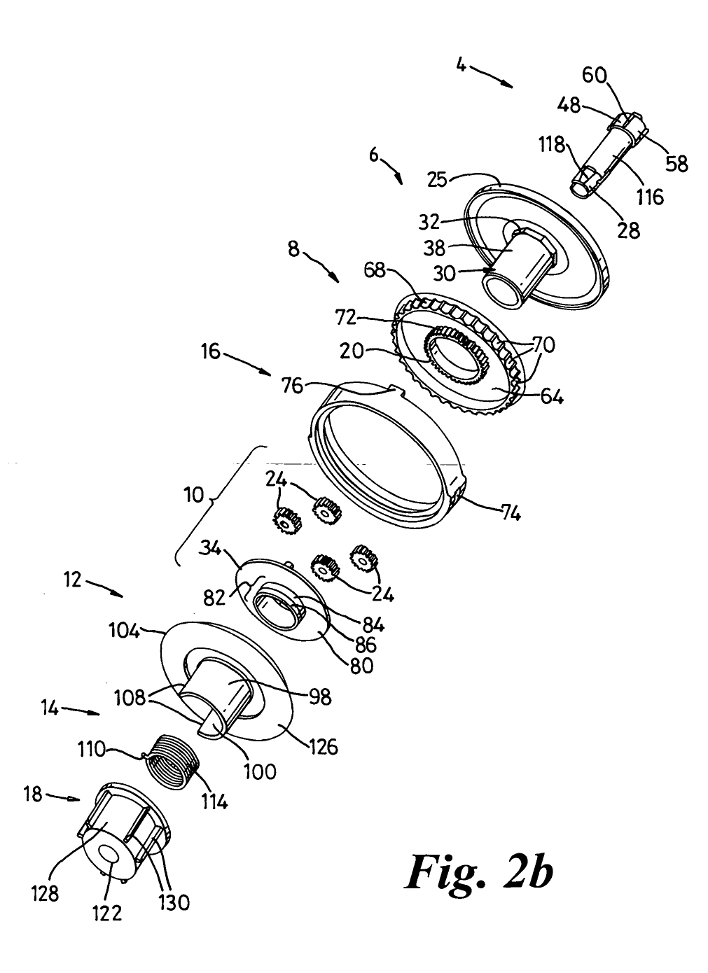

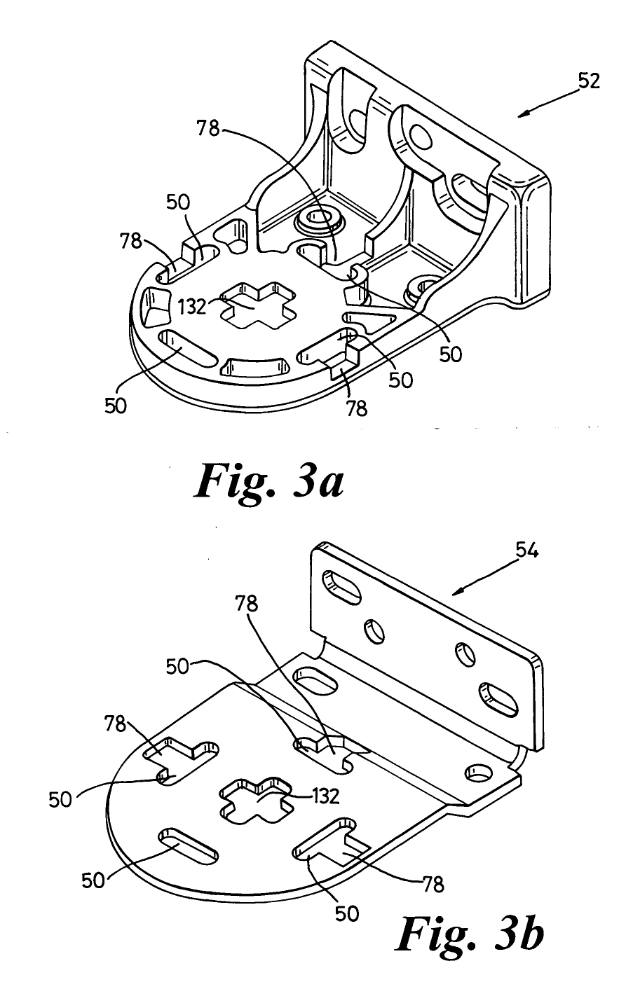

Dedicated mounting brackets 52, 54 such as those shown in FIGS. 3a and 3b, are required for use with the control unit of the invention. These may be plastic or metal. Typically each bracket 52, 54 is L-shaped and includes holes for receiving screws or other means suitable for attaching the bracket to the wall or other surface. The brackets 52, 54 will also include cavities or channels 50, 132 adapted to receive the locking-lug 46 of the centre-pin stop element 48 (cavity 132) and engagement pins 40 (cavities/channels 50) of the control unit 2. Brackets 52, 54 for use with embodiments of the invention comprising positioning a lug or lugs 76 extending from control unit 2 require the presence of the requisite number of additional cooperating recesses 78 in the bracket 52, 54. Typically, a plastics bracket 52 will be made from thermoplastic materials such as nylon, which are compatible with modern injection molding techniques. Metal brackets 54 will preferably be made from aluminum or steel, but other metals may be used as appropriate. Most preferably a metal bracket 54 will be made from painted steel.

In this embodiment of the invention, bracket 52, includes three additional recesses 78. Bracket 54, is adapted to interact with this embodiment of the invention by extending three of the receiving cavities 50 out towards the edge of the bracket, thereby facilitating engagement with lug 76. Three channels 78 are incorporated, although only one additional lug 76 is present in this embodiment so that the number of manufactured stock items may be kept to a minimum. The modified plastic and metal brackets 52, 54 will engage control unit 2 in any of three different orientations.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different devices and that various modifications can be accomplished without departing from the scope of the invention itself.

What is claimed is:

1. A control unit for use in a window blind head rail assembly including;
a driving member with a driving pulley so that force applied to the driving member will cause rotation of the driving pulley;
a sprocket support;
a system of transfer gears coupled to the driving member, the transfer gear system comprising a rotatable inner ring gear; one or more intermediate gears having fixed positions relative to the sprocket support and being rotatable about their own axes; a rotatable outer ring gear connected to a driven member; wherein rotation of the inner ring gear causes rotation of the one or more intermediate gears about their own axes, which causes rotation of the outer ring gear;
braking means to prevent the control unit from rotating other than in response to force applied via the driving member; and
a splined bush.

2. The control unit of claim 1 wherein the transmission of rotational motion from the driving member to the driven member via the transfer gear system gives a reduction to the splined bush.

3. The control unit of claim 1 wherein the inner ring gear is integral with the driving member

4. The control unit of claim 1 wherein the outer ring gear is integral with the driven member.

5. The control unit of claim 1 wherein the braking means is at least one wrap spring.

6. The control unit of claim 1 comprising an odd number of intermediate gears.

7. The control unit of claim 1 additionally comprising a centre-pin.

8. The control unit of claim 1 additionally comprising a chain guard housing.
